(19) United States
(12) Patent Application Publication
(10) Pub. No.: US 2013/0298187 A1
(43) Pub. Date: Nov. 7, 2013

(54) MANAGING VIRTUAL IDENTITIES

(71) Applicants: Alvin Black, Spanish Fork, UT (US); Jason Hammond, Lathrup Village, MI (US); Jamie P. Bowen, Somerset (UK); Tanmoy Hazra, West Bengal (IN); Robert Taylor, North Chelmsford, MA (US)

(72) Inventors: Alvin Black, Spanish Fork, UT (US); Jason Hammond, Lathrup Village, MI (US); Jamie P. Bowen, Somerset (UK); Tanmoy Hazra, West Bengal (IN); Robert Taylor, North Chelmsford, MA (US)

(73) Assignee: CA, Inc., Islandia, NY (US)

(21) Appl. No.: 13/464,085

(22) Filed: May 4, 2012

(51) Int. Cl. G06F 21/00

(52) U.S. Cl. 726/1

(57) ABSTRACT

Multiple personas associated with an identity are managed. Managing multiple personas may comprise providing a list of available personas associated with an authenticated user on a workspace, each available persona comprising policy information and configuration information, receiving a selection of a persona selected from the list of available personas and providing policy information and configuration information to a security enforcement point for a program for the selected persona. The persona can also include authentication information. The policy information may be used to determine access to a program.

### BACKGROUND

Aspects of the present disclosure are directed to the management of configurations of and access to computer based applications and services. More particularly, it is directed to the management of multiple user personas associated with an entity using a single global user logon.

The management of computer resources such as access to certain applications and services is important for efficient use of the resources. Management has become even more important since the growth in the use of internet services such as social sites. The line between personal accounts has been blurred and difficult to control. For example, Social Networking Sites and Email is used for both personal and business use.

Currently, a user logs into a system with a global user name and password, e.g., BIOS name and password. Then, for each application or service that requires a password, the user logs into the individual application or service using its user name and password. If the user wants to switch between a personal use and a business use, the user must logout of the system and re-login with a different global user name and password. Then, for each application or service that requires a password, the user must re-login with a different name and password.

### BRIEF SUMMARY

Disclosed is a method for managing virtual identities comprising providing a list of available personas associated with an authenticated user on a workspace, each available persona comprises policy information and configuration information, receiving a selection of a persona selected from the list of available personas and providing the policy information and configuration information to a security enforcement point for a program for the selected persona.

Also disclosed is a virtual persona management system comprising a storage device configured to store a list of available personas associated with authenticated user, each available persona in the list comprises policy information and configuration information for a program specific to the authenticated user, a user interface configured to be displayed on a workspace having a selectable list of available personas for the authenticated user and configured to receive a selection from the list of available personas as a current active persona; an active persona detection section configured to detect the selection of the current active persona and identify and tag the current active persona from the list of available personas stored in the storage device; and a security enforcement point interface configured to provide the policy information and the configuration information for the program associated with the current active persona to a security enforcement point.

Also disclosed is a server comprising a storage device configured to store a list of available personas associated with an authenticated user, each available persona in the list comprises policy information and configuration information for a program specific to the authenticated user, a first communication section configured to transmit a selectable list of available personas for the authenticated user and configured to receive a selection from the list of available personas as a current active persona, an active persona detection section configured to detect the selection of the current active persona and identify and tag the current active persona from the list of available personas stored in the storage device and a second communication section configured to transmit the policy information and the configuration information for the program associated with the current active persona to a security enforcement point.

Also disclosed is a computer program product. The computer program product comprises a computer readable storage medium having computer readable program code embodied therewith. The computer readable program code comprises program code configured to provide a list of available personas associated with an authenticated user on a workspace, each available persona comprising policy information and configuration information, to receive a selection of a persona selected from the list of available personas and to provide policy information and configuration information to a security enforcement point for a program for the selected persona.

### BRIEF DESCRIPTION OF THE FIGURES

FIG. 1 illustrates an example of a persona management system in accordance with an aspect of the disclosure;

FIG. 2 illustrates another example of a persona management system in accordance with an aspect of the disclosure;

FIGS. 3 and 4 illustrate an example of a method for managing a plurality of virtual personas in accordance with an aspect of the disclosure;

FIG. 5 illustrates an example of a prelaunch detection in accordance with an aspect of the disclosure;

FIG. 6 illustrates an example, of post launch adjustments based upon a newly selected persona in accordance with an aspect of the disclosure;

FIG. 7 illustrates an example of a logical progression of the Persona Manager in accordance with an aspect of the disclosure; and

FIG. 8 illustrates an example of a persona in accordance with an aspect of the disclosure.

### DETAILED DESCRIPTION

The following definitions will be used throughout this document:

Workspace—A client platform or other logical user workspace. For example, this could be a presentation manager component of an operating system, a mobile platform, or similar platform.

Identity—A representation and attributes of an authenticated entity (typically a “user”).

Identity Provider or Single Login Authentication Section—A service or component which provides authentication claims and other attributes related to an identity.

Session—A period of time within a workspace associated with the active “login” or other control of the workspace by an entity (typically a user).

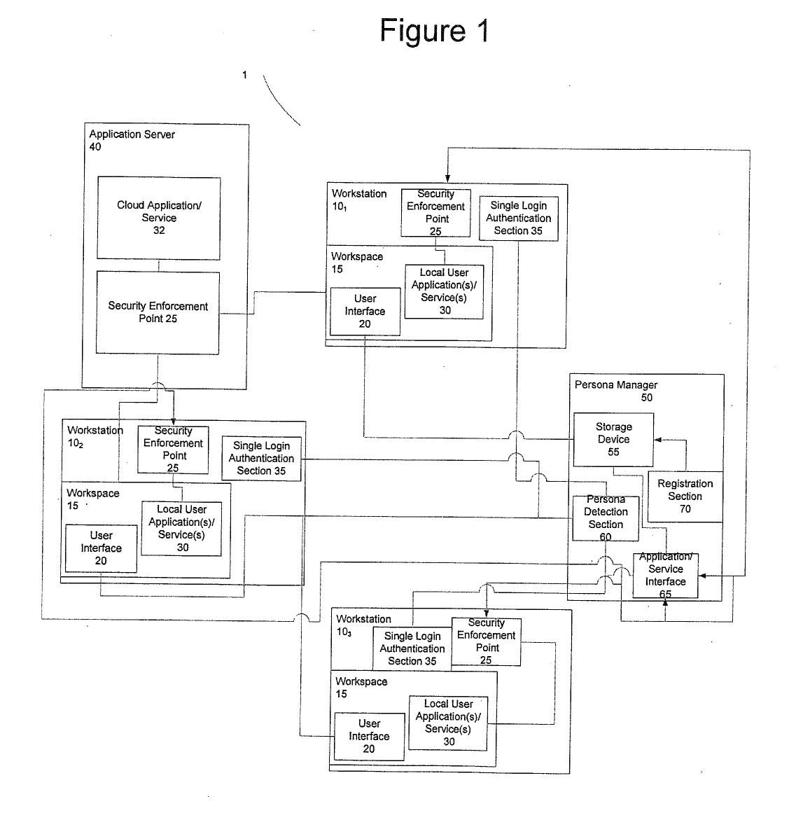

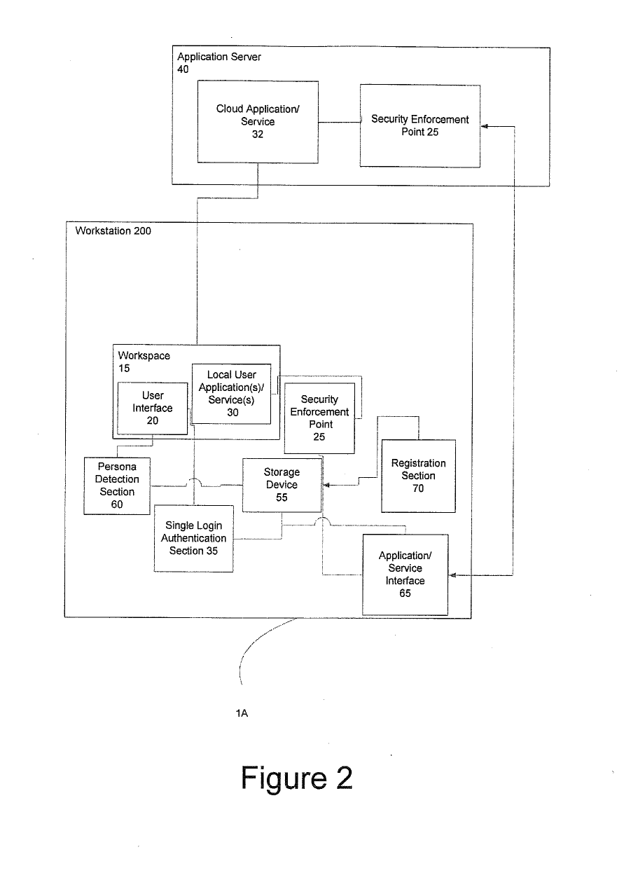

FIGS. 1 and 2 illustrate examples of systems for managing multiple personas (collectively “100”) associated with an identity, e.g., an entity or a user. The systems 1 and 1A include a Persona Manager 50, which is a component or service logically available to or within a workspace 15. The Persona Manager 50 can be separate from a workstation 10 as depicted in FIG. 1 or integrated as depicted in FIG. 2. Except for the location of the persona manger 50 and the use of a Communication Section 80 to transmit and receive a list of available personas and receive a selection, the systems 1, 1A are the same.

FIG. 1 illustrates a Persona Manager 50 remote from a plurality of workstations (collectively “10”). This allows for users to manage their personas across various workspaces (collectively “15”) and workstations (collectively “10”). Additionally, a companies IT manager or risk manager can control the Persona Manager 50 without accessing each individual workstation 10. Thus, the remote Persona Manager 50 acts as a central service.

The Persona Manager 50 includes a Storage Device 55, a Persona Detection Section 60, an Application/Service Interface 65 and a Registration Section 70. When the Persona Manager 50 is remote, the persona manager 50 includes a Communication Section 80 configured to transmit and receive data from the workstations 10. Communication Section 80 interacts with the Storage Device 55 to retrieve a list of available personas. The Communication Section 80 further interacts with an single login authentication section 35 to receive the user name to look up the list of available personas. The Communication Section 80 comprises a transmitter/receiver and a processing section. The processing section controls the interactions between the single login authentication section 35 and the Storage Device 55 and controls the transmitter/receiver. The transmitter/receiver can be a network card or any network interface capable of transmitting or receiving wired or wireless data.

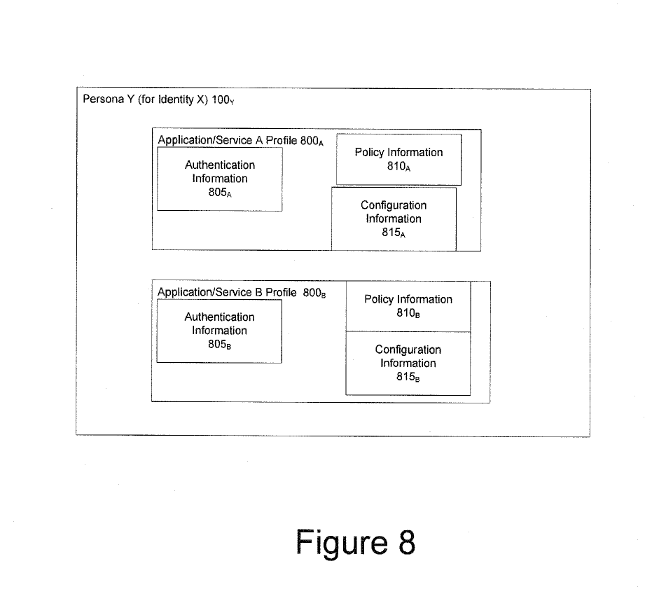

The Storage Device 55 is configured to store at least one persona 100 associated with an identity. The persona 100 can be in the form of a data record. A persona 100 will be described in detail with respect to FIG. 8. All of the personas 100 associated with an identity are indexed by the identity user name, e.g., authentication information. Therefore, when the Persona Manager 50 obtains an identity user name, all personas 100 associated with the identity user name can be retrieved for display. The Storage Device 55 can be any known storage device such as, but not limited to, magnetic, optical, electronic, electromagnetic, infrared, or semiconductor system, apparatus, or device, or any suitable combination of the foregoing.

The Storage Device 55 can also include a program of instructions for causing the Persona Detection Section 60, Application/Service Interface 65 and Registration Section 70 to execute the functionality described herein. Alternatively, the Persona Manager 50 can have a separate storage device for storing the program.

Additionally, the Storage Device 55 can include information related to currently launched applications for each persona. For example, this information can include an application or service identifier, service states and configuration information. This information can be later retrieved by either the Persona Detection Section 60 or the Application/Service Interface 65 which allows applications or services to be re-configured when a previously selected persona is selected again.

The Persona Detection Section 60 interacts with a user interface 20 as depicted in FIG. 2on the workspace 15 (or the Communication Section 80 as depicted in FIG. 1) by detecting which of the multiple personas associated with an identity was selected. Once a selection is received and identified, the Persona Detection Section 60 retrieves the appropriate persona 100 from the Storage Device 55 and relays information in the persona 100 to the Application/Service Interface 65. If the Persona Manager 50 is remote from the workstation 10, as depicted in FIG. 1, the selection is received by the Communication Section 80 via a network, such as a LAN (the network is not shown).

The Application/Service Interface 65 interacts with the application or service and forms a Communication Section 80. This interaction can be direct or indirect. Indirect interaction can be facilitated through the Security Enforcement Point 25 or a standard API. APIs are well known and will not be described herein in detail. The Application/Service Interface 65 is configured to provide information from the current active persona to the application or service 30, 32. (directly or indirectly through a Security Enforcement Point 25 or API). Depending on the application or service, 30, 32, the application or service 30, 32 might have the ability to directly communicate with the Application/Service Interface 65. The Application/Service Interface 65 uses a transmitter and receiver to interact with the applications or service 30, 32. The applications or services can be local applications/services 30 or cloud application/services 32. The transmission and reception and receiver can be wired or wireless.

Additionally, the Application/Service Interface 65 can be used to gather information (directly or indirectly) from currently launched application such as application or service identifier, service states and configuration information or applications (when launched or when they are closed or otherwise made unavailable).

The Registration Section 70 allows a person such as a user or IT manager to pre-configure and register the personas 100. The Registration Section 70 can include a graphical user interface with either a form fillable application or drop down menus. The Registration Section 70 interacts with the Storage Device 55. For each application, an Application/Service Profile 800 is generated. The Application/Service Profile 800 can include, but is not limited to, authentication information 805, policy information 810 and configuration information 815. Authentication information 805 refers to application or service specific user names and passwords or codes. Policy Information 810 refers to the ability to use a specific application or service with the persona and user rights to the application or service. Therefore, an IT manager or risk manager of a company can prevent access to certain applications or services provide a restricted or limited access to certain applications or services or provide full access to certain applications or services, using the policy information 810. In an embodiment, if the policy information 810 is not provided, the systems (1 and 1A) will default to full access.

An entity performs a single login via a single login authentication section 35 associated with the workstation 10 or workspace 15, e.g., a global login. The authentication of the identity can either be provided by authentication mechanisms associated with the workspace 15 or workstation 10 (as depicted in FIGS. 1 and 2). Alternatively, the single login authentication section 35 can be incorporated into the Persona Manager 50 itself. The specific mechanism for authentication could include any of the various mechanisms supported in the industry, and could also include authentication via third-party identity providers.

In an embodiment, the single login authentication section 35 interacts with the Application/Service Interface 65 and provides the appropriate user name and password. In another embodiment, the user name and password is provided directly to a user interface 20. The user name and password is then used to “look up” the associated personas 100.

Once an entity logs in, the user interface 20 is displayed. The user interface 20 is configured to display all available personas 100 for the identity. Additionally, the user interface 20 is configured to receive a selection of one of the personas, e.g., 100₁. The user interface 20 can include drop down menus having a list of the available personas 100 associated with the logged in entity (identity). The user interface 20 interacts with the Persona Detection Section 60. In an embodiment, the user interface 20 also interacts with the Storage Device 55 to retrieve the available personas 100. Alternatively, the user interface 20 can receive the list of available personas 100 associated with an entity from the Communication Section 80.

The system 1, 1A can also include a Security Enforcement Point 25 configured for pre-launch detection. The Security Enforcement Point 25 determines if the selected persona, e.g., 100₁ is allowed to access an application or service 30, 32 prior to launch using the policy information 810 received from the Application/Service Interface 65. If access is allowed or allowed with limited rights, the Security Enforcement Point 25 can either directly or indirectly configure the application or service 30, 32 based upon the configuration information 815 received from the Application/Service Interface 65. Furthermore, the Security Enforcement Point 25 can either directly or indirectly provide the application or service 30, 32 with the appropriate authentication information 805 received from the Application/Service Interface 65. In an embodiment, and depending on the application or service 30, 32, the Persona Detecting Section 60 can communicate directly with the Security Enforcement Point 25 and bypass the Application/Service Interface 65.

While the Security Enforcement Point 25 has been depicted as a single entity either in the workstation 10 or application server 40, a different Security Enforcement Point 25 can be used for each different application. Therefore, there can be multiple Security Enforcement Points 25. For example, when an entity attempts to launch a specific application or service 30, 32, its specific Security Enforcement Point 25 is triggered. At this point, the specific Security Enforcement Point 25 interacts with the Persona Manager 50 (via the Application/Service Interface 65) or user interface 20, to obtain the information associated with the selected persona, e.g., 100₁ (either directly or through APIs). The Security Enforcement Point 25 is policy driven.

Additionally, when a new persona, e.g., 100₂, is selected, the Security Enforcement Point 25 determines if the newly selected persona 100₂ is allowed to access an application or service 30, 32 that are already launched using the policy information, e.g., 810₂, received from the Application/Service Interface 65. If access is not allowed, the Security Enforcement Point 25 can either directly or indirectly cause the application or service 30, 32 close or otherwise make the application or service 30, 32 unavailable for the persona or session. For example, the Security Enforcement Point 25 can change the access or permission rights within the application or service 30, 32. In an embodiment, information related to these applications, e.g., closed or otherwise made unavailable, can be sent to the Application/Service Interface 65 for storage in the Storage Device 55.

While the Security Enforcement Point 25 is depicted in the workstation 10 and in a cloud application server 40, the Security Enforcement Point 25 can be included in the Persona Manager 50, workspace 15 or in the application or service 30, 32 itself.

The Security Enforcement Point 25 can be, but is not limited to, an application driver, an internet browser plugin, proxy, engine, gateway, and a BIOS driver. The functionality of the Secure Enforcement Point 25 is driven by the policy set in the selected persona, e.g., 100₁.

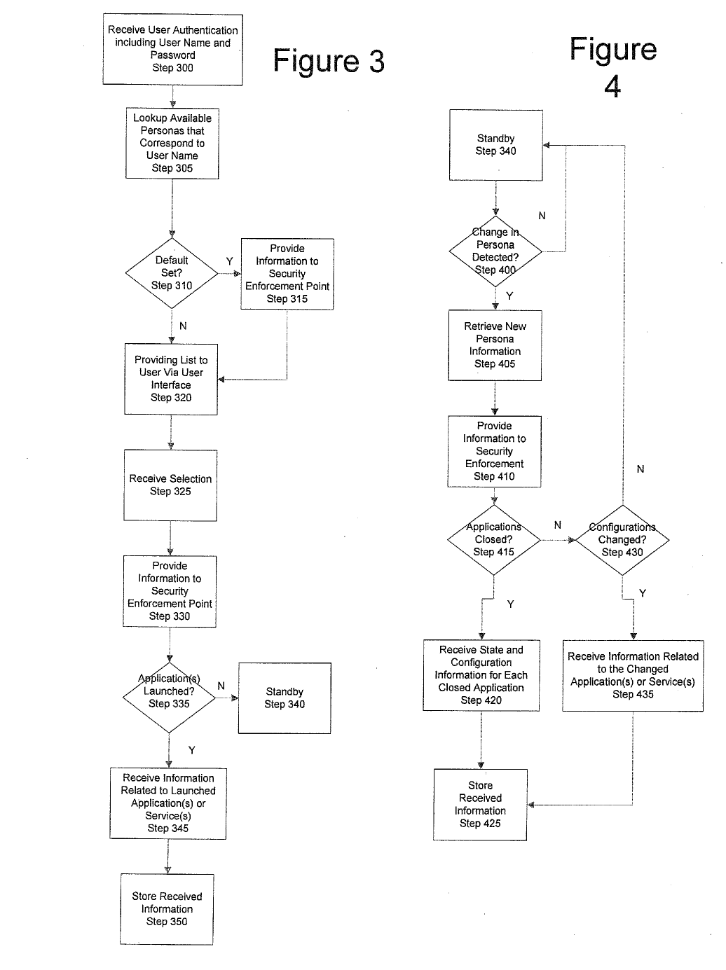

The method of managing multiple personas 100 associated with an identity will now be described with respect to FIGS. 3, 4, and 7.

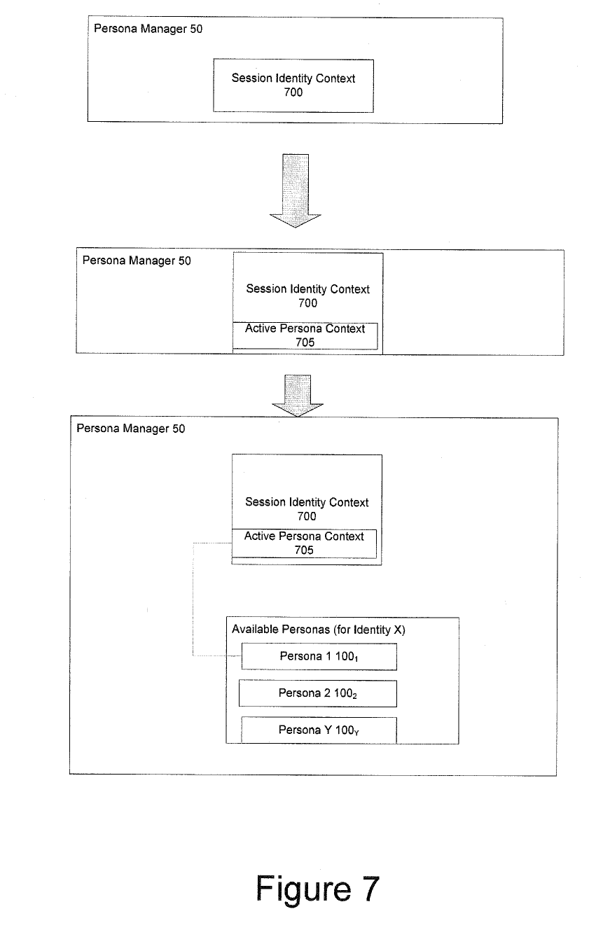

FIG. 3 illustrates a procedure performed by the Persona Manager 50 when an initial persona is selected. FIG. 4 illustrates a procedure performed by the Persona Manager 50 when a new persona is selected subsequent to an initial selection. FIG. 7 illustrates a logical progression of the Persona Manager 50.

At step 300, the Persona Manager 50 receives global authentication information include a user name and password of an entity. The Persona Manager 50 maintains an “identity context” for each session within the workspace 15. This context provides the details about the entity (typically a “user”) that is logged in (or otherwise in control of the workspace session). The Session Identity Context 700 is illustrated on the top of FIG. 7. As noted above, the authentication information can be provided in any known manner and thus will not be described herein in detail.

At step 305, using the authentication information, the Persona Manager 50 looks up the available personas 100 associated with the identity, e.g., user name In another embodiment, the user interface 20 looks up the available personas 100 associated with the identity from the Storage Device 55.

For example, the bottom of FIG. 7 illustrates a list of available personas for Identity X, i.e., Personas 1-Y.

For each Session Identity Context 700, the Persona Manager 50 also maintains an active “persona context” 705. The Active Persona Context 705 is shown in the middle of FIG. 7. The Active Persona Context 705 contains a logical reference to the available personas 100 for the current identity available in the session identity context 700, as shown in the bottom of FIG. 7.

The Persona Manager 50 can be preconfigured to use a default persona. The default persona can be location specific. For example, the Persona Manager 50 can detect an IP address, MAC address or other identifier associated with a physical machine and set the appropriate default. For example, if an entity is using a computer associated with a company, the default persona can be a business persona.

At decision step 310, the Persona Manager 50 determines if a default persona should be provided. If a default persona is predetermined (“Y” at decision step 310), the default persona is set in the active “persona context”. Additionally, the information associated with the default persona is provided to the Security Enforcement Point 25 at step 315 whereby the information is effectively made available to the outside applications to allow them to be dynamically configured for different users based on the information in the persona context. This can be on an application or service 30, 32 specific basis, e.g., request based.

If a default persona is not predetermined (“N” at decision step 310), a list of available personas 100 is provided to the entity via the user interface 20 (via the Communication Section 80 if the Persona Manager 50 is remote from the workstation) at step 320. Additionally, if the default persona is set (at step 315), the list is still provided at step 320. At step 325, the Persona Detection Section 60 detects a selection of a persona. In an aspect of the invention, the Persona Detection Section 60 receives the selection from the Communication Section 80. The selected persona set in the Active Persona Context 705. Additionally, information associated with the selected persona is provided to the Security Enforcement Point 25 at step 330 whereby the information is effectively made available to the outside applications to allow them to be dynamically configured for different users based on the information in the persona context. In other words, when the entity associated with a workspace session accesses (or attempts to access) an application or service 30, 32, the Persona Manager 50 acts as an identity and policy broker to establish an actual identity and policy which matches the information logically referenced in the current persona context 705 for the service or application 30, 32 being accessed (or attempted).

Instance data related to each active application running or accessible within the workspace 15 can also be maintained by the Persona Manager 50 within the current persona context 705. This instance data is used by the Persona Manager 50 to modify the active application contexts within a workspace 15 whenever a new persona is chosen. At decision step 335, a determination is made if there are any launched applications. For example, the Persona Manager 50 can receive a notification from either the application, API or Security Enforcement Point 25 when an application or service 30, 32 is launched. If an application or service 30, 32 is launched (“Y” at decision step 335), the Persona Manager 50 interacts with the application or service 30, 32 directly via the Application/Service Interface 65 or indirectly via an API (or with the Security Enforcement Point 25) to obtain the information at step 345.

This information is also stored in the Storage Device 55 at step 350. A logical link to the information is added or set in the persona context 705. In an embodiment, this information is deleted from the Storage Device 55 after a preset period of time. The information includes an application or service identifier and state information. The state information can include options, setting and other configuration data.

If no applications are detected as launched (“N” at decision step 335), the Persona Manager 50 is placed in a standby mode at step 340.

Once in standby mode (step 340), the Persona Detection Section 60 acts as a wakeup sensor by monitoring the user interface 20 for a new persona selection (decision step 400). The Persona Manager 50 allows an entity to switch the active persona (i.e.: change the persona currently selected in to the Active Persona Context 705). If a new persona is selected (“Y” at decision step 400), e.g., 100₂, information in the new persona is retrieved from the Storage Device 55 at step 405. The newly selected persona is set in the Active Persona Context 705. Additionally, information associated with the newly selected persona is provided to the Security Enforcement Point 25 at step 410 whereby the information is effectively made available to the outside applications to allow them to be dynamically configured for different users based on the information in the persona context 705. In an embodiment, all of the information from the previous Active Persona Context 705 is stored in the Storage Device 55. In other words, the Persona Manager 50 acts as an identity and policy broker within the workspace 15 to properly re-establish real identities and policies for any active applications or services that are based on the new information set into the current persona context 705. In an embodiment, the Persona Manager 50 only provides the application or service profile 800 for applications or services currently active within a session workspace 15. Additionally, the Person Manager 50 determines if the newly selected persona was a previously selected persona and if the currently active applications or services were previously active. If the answer to both determinations is “YES”, the previous configuration information is also provided with the application profile 800. This may include closing down a service or application 30, 32 which is no longer available to the current persona.

At decision step 415, a determination is made if there are applications or services that were closed because they were no longer available for the current persona, e.g., 100₂. For example, the Persona Manager 50 can receive a notification from either the application (or service), API or Security Enforcement Point 25 when an application or service 30, 32 is closed. If an application or service 30, 32 is closed (“Y” at decision step 415), the Persona Manager 50 interacts with the application or service 30, 32 directly via the Application/Service Interface 65 or indirectly via an API (or with the Security Enforcement Point 25) to obtain information related to the application or service 30, 32 that was closed at step 420. The information includes an application or service identifier, service states and configuration information. This information is stored in the Storage Device at step 425. This information can be used to re-configure the same applications or services to their prior state when a closed persona entry once again became the active persona.

If no application was closed (“N” at decision step 415), the Persona Manager 50 determines if the configurations of any launched application were changed at step 430. For example, the Persona Manager 50 can receive new configuration from either the application, API or Security Enforcement Point 25 when an application or service 30, 32 is re-configured. If the Persona Manager 50 receives new configuration information (“Y” at decision step 430), the information is stored in the Storage Device 55 and set in the persona context 705. This information is received for each application or service that was reconfigured. When no applications or services are reconfigured (“N” at decision step 430), the Persona Manager 50 returns to a standby mode (step 340).

If at decision step 400, the Persona Detection Section 60 does not detect a new selection (“N” at decision step 400), the Persona Manager 50 remains in a standby mode (step 340).

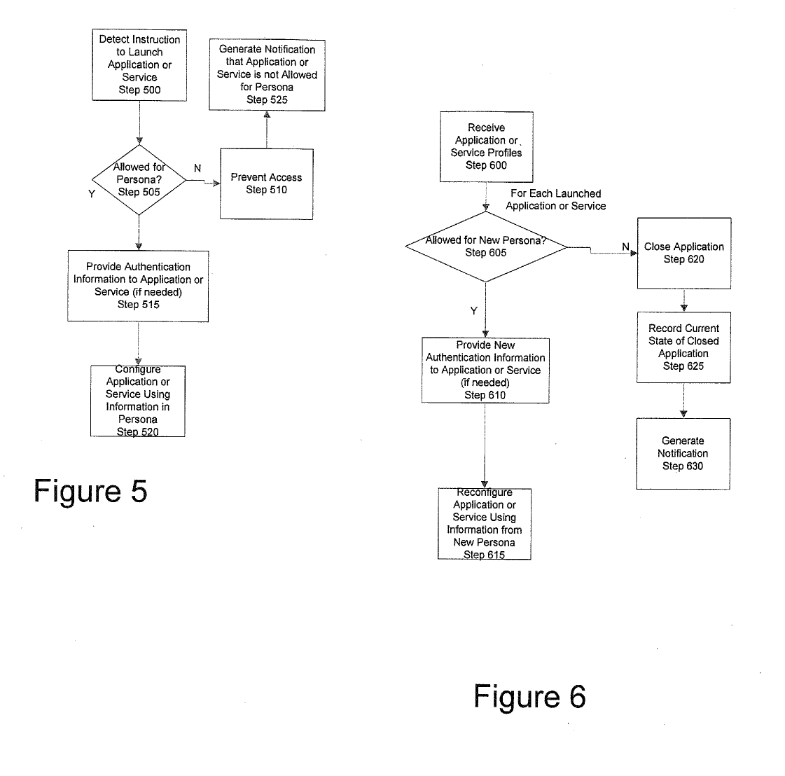

FIG. 5 illustrates an example of a prelaunch detection in accordance with the aspect of the disclosure. At step 500, the Security Enforcement Point 25 detects a launch event. The Security Enforcement Point 25 interacts with the Persona Manager 50 (via the Application/Service Interface 65) to obtain the authentication information 805, policy information 810 and configuration information 815 for the application or service 30, 32. The Security Enforcement Point 25 does not need to know the selected persona to obtain the necessary information. The Security Enforcement Point 25 can specify the application or service 30, 32 using an identifier. The Persona Manager 50 provides the appropriate application/service profile 800. At decision step 505, the Security Enforcement Point 25 determines if the requested application or service 30, 32 is allowed for the persona using the policy information, e.g., 810_{A} for application or service A. If application or service A is not allowed for the selected persona (“N” at decision step 505), access is prevented at step 510. The prevention of access to an application is well known and will not be described herein in detail.

A notification is generated at step 525, informing the entity that the selected persona is not authorized to have access to the request application or service, e.g., application or service A. In an embodiment, the Security Enforcement Point 25 generates this notification. In another embodiment, if the application or service 30, 32 is persona aware, the application or service, 30, 32 generates the notification. Alternatively, the Persona Manager 50 generates the notification.

In an embodiment, the Security Enforcement Point 25 can request information related to other personas for the entity. For example, Security Enforcement Point 25 can issue a notification to the Persona Manager 50 indicating that the persona was denied access. Responsive to this notification, the Persona Manager 50 can identify any persona 100 associated with the entity that is authorized access based upon the policy information 810 associated with the application or service (e.g., application or service A). Then a notification can be generated to inform the entity of the proper persona, e.g., 100_{Y}.

If application or service A is allowed for the selected persona (“Y” at decision step 505), the Security Enforcement Point 25 provides authentication information, e.g., 805_{A}, to the application or service 30, 32 (e.g., application or service A) at step 515 (either directly or indirectly).

Additionally, if access is allowed or allowed with limited rights, the Security Enforcement Point 25 can either directly or indirectly configure the application or service 30, 32 based upon the configuration information e.g., 815_{A} received from the Application/Service Interface 65 at step 520.

As described above, when an application or service is launched, instance data related to each active application running or accessible within the workspace can be provided to Persona Manager 50.

FIG. 6 illustrates an example of post launch adjustments based upon a newly selected persona in accordance with an aspect of the disclosure. When a new persona is selected, e.g., 100₂ information related to the newly selected persona is provided to the Security Enforcement Point 25. Specifically, for any application that is currently launched, the corresponding application profile 800 is provided to the Security Enforcement Point 25(multiple enforcement points). The Persona Manager 50 can determine the currently launched applications or services from the instant data stored in the Storage Device 55. At step 600, the Security Enforcement Point 25 receives the application or service profile, e.g., 800_{B} from the Persona Manager.

For each application or service 30, 32 that is launched, the Security Enforcement Point 25 determines if the application or service 30, 32 is allowed for the new persona using the policy information 810_{B} at step 605. If the application or service 30, 32 is not allowed, the application or service is closed in step 620. The information related to the current state of the closed application is provided to the Persona Manager 50 (via the Application/Service Interface 65).

The information can be transmitted by the application or service 30, 32 itself, the API or the Security Enforcement Point 25. The Persona Manager 50 records the received information into the Storage Device 55 at step 625. At step 630, a notification is generated that the application or service 30, 32 is not allowed for the persona 100. In an embodiment, the Security Enforcement Point 25 generates the notification. In another embodiment, the Persona Manager 50 generates the notification.

If at step 605, the application or service 30, 32 is allowed for the new persona, e.g., 100₂, the authentication information 805 and configuration information 815 (comprising any previous settings or configuration received from the Persona Manager 50 at step 600) is applied at steps 610 and 615. As such, the configuration information 815 acts as a default configuration, which can be modified using the previous settings or configurations received from the Persona Manager 50. In an embodiment, the authentication information 805 and configuration information 810 is directly or indirectly provided to the applications or services 30, 32 by the Security Enforcement Point 25.

FIG. 8 illustrates an example of a persona 100_{Y} for identity X. The persona 100_{Y} includes an application/service profile 800 for each application or service 30, 32 associated with the persona 100_{Y}. The application/service profile 800 is created during registration of a persona 100. An application/service profile 800 can be added, deleted or modified at any time. In an embodiment, only authorized entities can add, delete or modify a persona 100 and/or an application/service profile 800. Therefore, the Registration Section 70 includes an authentication section. Each application/service profile 800 can include at least authentication information 805, policy information 810 and configuration information 815. Not all application/service profiles 800 include all three. In fact, many applications or services do not require authentication information 805.

FIG. 8 illustrates two application/service profiles 800_{A} and 800_{B}, which are associated with Application or Service A and B, respectively. Application/Service A Profile 800_{A} includes authentication information 805_{A}, policy information 810_{A} and configuration information 815_{A}. Similarly, Application/Service B Profile 800_{B} includes authentication information 805_{B}, policy information 810_{B} and configuration information 815_{B}.

In another embodiment, the Persona Manager 50 causes all applications or services that are allowed for a selected persona to be automatically launched and configured using the configuration information 815 and/or authentication information 805. Launched directed by the Persona Manager 50. In an embodiment, during the persona registration, a path of the application and/or the name of the corresponding API are specified. The Persona Manager 50 executes operating system commands If the application or service 30, 32 are web-based, the Persona Manager 50 launches a web browser with using the appropriate URL. Alternatively, the Persona Manager 50 can instruct a Security Enforcement Point 25 to automatically launch the application/service 30, 32.

As will be appreciated by one skilled in the art, aspects of the present disclosure may be embodied as a system, method or computer program product.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “point”, “section”, “interface” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terms “persona manager” “management system” “interface” “section” or “point”, “device” and “network” as may be used in the present disclosure may include a variety of combinations of fixed and/or portable computer hardware, software, peripherals, and storage devices. The system may include a plurality of individual components that are networked or otherwise linked to perform collaboratively, or may include one or more stand-alone components. The hardware and software components of the computer system of the present application may include and may be included within fixed and portable devices such as desktop, laptop, and/or server, and network of servers (cloud).

### Example 1

A user Bob has two defined personas: a business persona and a personal persona. The business persona is set up to include settings or rules as follows:

Application/Service Profile 1 includes authentication information for JOHN DOE EMAIL SERVICE, policy information allowing access to JOHN DOE EMAIL SERVICE and configuration information for a corporate email account.

Application/Service Profile 2 includes policy information limiting access to Facebook to a corporate Facebook account and configuration information for the corporate account.

Application/Service Profile 3 includes policy information Prohibiting access to Hotmail services.

The personal persona may have been set up to include settings or rules as follows:

Application/Service Profile 1 includes policy information Prohibiting access to JOHN DOE EMAIL SERVICE.

Application/Service Profile 2 includes policy information limiting access to Facebook to a personal Facebook account and configuration information for the personal account/

Application/Service Profile 3 includes policy information allowing access to Hotmail service, authentication information of user name and password and configuration information for a personal hotmail email account.

Bob logs in (authenticates) to the workspace 15 (and indirectly to Persona Manager 50). This sets the session identity context 700 for the session to the identity associated with Bob. The default persona of business is also selected.

Bob attempts to access the corporate email service. This access is authorized and authenticated to the service via a combination of a corresponding Security Enforcement Point 25 and the Persona Manager 50 using Application/Service Profile 1 from the Business Persona and using the user name and password information in the authentication information and configuration information for the corporate email account service that is associated with Bob in the persona.

Bob attempts to access Facebook. This access is authorized and authenticated to the service via a combination of a corresponding Security Enforcement Point 25 and the Persona Manager 50 using Application/Service Profile 2. The corporate Facebook account information is used, since the corporate account is the account associated with Bob's business persona in the policy information.

Bob attempts to access Hotmail. Based upon the Application/Service Profile 3, access is denied by a combination of the corresponding Security Enforcement Point 25 and the Persona Manager 50 and Bob are informed that access is not available in the business persona. In an embodiment, Bob is asked to pick a persona where the access is available and the persona could be changed accordingly to grant access, i.e., personal persona.

Bob then selects his personal persona. This triggers the following:

Bob is logged out of the corporate email account, since that access is prohibited under the personal persona using Application/Service Profile 1 from the personal persona.

The Facebook account which is active is changed to Bob's personal Facebook account, since that is the account associated with Bob's personal persona based upon Application/Service Profile 2 from the personal persona. The Security Enforcement Point would cause the original persona to logout of the service and then re-login using the user credentials supplied by the Personal Manager. This logout and re-login would happen automatically without Bob entering the user credentials.

Bob now attempts to access Hotmail, and the access is successful, since it is allowed under the personal persona based upon Application/Service Profile 3 from the personal persona.

### Example 2

An employee within an enterprise might be a services contractor working for two different customers, and might also do personal work on a company's systems. Three personas 100₁₋₃ could be established for this employee, allowing the employee to logically login only once, but easily switch the context of their work throughout the business day. Each context switch would merely require the selection of the relevant persona, which selection would automatically adjust the login context and permissions to the underlying systems that would be pertinent to the selected persona. Hence, a user who switches their persona to “personal” would have access to personal systems such as “hotmail” automatically become available, but access to other systems might then be restricted while the “personal” persona was active. The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method for managing virtual identities comprising:
providing a list of available personas associated with an authenticated user on a workspace, each available persona comprising policy information and configuration information;
receiving a selection of a persona selected from the list of available personas; and
providing policy information and configuration information to a security enforcement point for a program for the selected persona.

2. The method for managing virtual identities according to claim 1,
determining an allowable program for the selected persona using policy information corresponding to the selected persona; and
preventing access to the program that is not allowable for the selected persona.

3. The method for managing virtual identities according to claim 1, further comprising:
authenticating the authenticated user using single sign on.

4. The method for managing virtual identities according to claim 1, further comprising:
registering each persona by receiving the policy information and the configuration information the program.

5. The method for managing virtual identities according to claim 2, further comprising;
determining whether to set a default persona; determining an access location; and
providing a default persona based upon the access location.

6. The method for managing virtual identities according to claim 5, wherein the default persona is a business persona.

7. The method for managing virtual identities according to claim 1, further comprising:
launching automatically the program that is allowable for the selected persona.

8. The method for managing virtual identities according to claim 2, further comprising:
receiving a new persona selection from the list of available personas;
providing policy information and configuration information to the security enforcement point for the program for the new selected persona;
determining the allowable program for the new selected persona using policy information corresponding to the new selected persona;
causing the program that is not allowable for the new selected persona to be closed; and
causing an active program which is allowable for the new selected persona to be reconfigured using the authentication information and configuration information for the new selected persona.

9. The method for managing virtual identities according to claim 8, further comprising:
gathering a program identifier, service state and configuration information for the closed program; and
storing the program identifier, service state and configuration information, wherein the stored program identifier, the service state and the configuration information are used to re-configure the program when a previous selected persona is selected again.

10. The method for managing virtual identities according to claim 2, wherein for the allowable program, the program is configured for the selected persona using the configuration information.

11. The method for managing virtual identities according to claim 2, further comprising:
generating a notification when the program is not allowed for the selected persona.

12. A virtual persona management system comprising:
a storage device configured to store a list of available personas associated with an authenticated user, each available persona in the list comprises policy information and configuration information for a program specific to the authenticated user;
a user interface configured to be displayed on a workspace, the user interface comprising a selectable list of available personas for the authenticated user and configured to receive a selection from the list of available personas as a current active persona;
an active persona detection section configured to detect the selection of the current active persona and identify and tag the current active persona from the list of available personas stored in the storage device; and
an security enforcement point interface configured to provide the policy information and the configuration information for the program associated with the current active persona to a security enforcement point.

13. The virtual persona management system of claim 12, further comprising:
an authentication section configured to authenticate the user via a single sign on, wherein when the user is authenticated the list of available personas is provided to the authenticated use.

14. The virtual persona management system of claim 12, wherein said storage device, active persona detection section and security enforcement point interface is located is a server, and said storage device is configured to store a plurality of list of available persona corresponding to a plurality of authenticated users.

15. The virtual persona management system of claim 12, further comprising a persona registration section configured to create each available persona by defining the policy information and the configuration information.

16. The virtual persona management system of claim 12, wherein the security enforcement point interface is further configured to receive information related to an active program on the workspace in the selected persona, wherein the received information is stored in the storage device.

17. The virtual persona management system of claim 12, wherein when a new persona is selected by the authenticated user from the list of available personas, the policy information and configuration information is provided to the security enforcement point for a program for the new selected persona, and the program not authorized for the new selected persona is closed down and information related to the closed program is gathered and stored in the storage device.

18. The virtual persona management system of claim 17, wherein the information related to the closed program comprises a program identifier, service state and configuration information for the closed program and wherein the stored program identifier, the service state and the configuration information is used to re-configure the program when the persona is selected again.

19. The virtual persona management system of claim 17, wherein an active program which is allowable for the new selected persona is reconfigured using configuration information for the new selected persona.

20. The method for managing virtual identities according to claim 1, wherein an available persona comprises authentication information, configuration information and policy information and when the persona is allowed access to the program, the program is provided with the authentication information.

21. The method for managing virtual identities according to claim 11, further comprising providing a list of personas that are allowed to access the program.

22. A computer program product comprising:
a computer readable storage medium having computer readable program code embodied therewith, the computer readable program code comprising:
computer readable program code configured to provide a list of available personas associated with an authenticated user on a workspace, each available persona comprising policy information and configuration information;
computer readable program code configured to receive a selection of a persona selected from the list of available personas; and
computer readable program code configured to provide policy information and configuration information to a security enforcement point for a program for the selected persona.

23. A server comprising:
a storage device configured to store a list of available personas associated with an authenticated user, each available persona in the list comprises policy information and configuration information for a program specific to the authenticated user;
a first communication section configured to transmit a selectable list of available personas for the authenticated user and configured to receive a selection from the list of available personas as a current active persona;
an active persona detection section configured to detect the selection of the current active persona and identify and tag the current active persona from the list of available personas stored in the storage device; and
a second communication section configured to transmit the policy information and the configuration information for the program associated with the current active persona to a security enforcement point.

24. The server of claim 23, wherein the second communication section is further configured receive information related to an active program on the workspace in the selected persona, wherein the received information is stored in the storage device.

25. The server of claim 23, further comprising:
a persona registration section configured to create each available persona by defining the policy information and the configuration information.
